(19) United States
(12) Patent Application Publication
(10) Pub. No.: US 2026/0233645 A1
(43) Pub. Date: Aug. 13, 2026

(54) SEAT BASE FOR A CHILD RESTRAINT

(71) Applicant: Dorel Juvenile Group, Inc., Foxboro, MA (US)

(72) Inventor: Jacob S. BAILEY, Columbus, IN (US)

(21) Appl. No.: 19/538,251

(22) Filed: Feb. 12, 2026

Related U.S. Application Data
(60) Provisional application No. 63/757,986, filed on Feb. 13, 2025.

(51) Int. Cl. B60N 2/28

(52) U.S. Cl. CPC B60N 2/2821; B60N 2/2818; B60N 2/2875

(57) ABSTRACT

A child restraint includes a juvenile seat adapted to hold a child for transportation in a vehicle, and a seat base configured to support the juvenile seat and configured to attach to an underlying vehicle seat. The seat base includes a seat-base foundation formed to include a belt-installation path configured to receive an attachment belt to secure the seat base to the vehicle seat and an angle-adjustment foot configured to control a tilted orientation of the seat base and the juvenile seat relative to the vehicle seat.

### PRIORITY CLAIM

This application claims priority under 35 U.S.C. § 119(e) to U.S. Provisional Patent Application No. 63/757,986, filed Feb. 13, 2025, which is expressly incorporated by reference herein in its entirety.

### BACKGROUND

The present disclosure relates to a child safety device, and particularly to a child restraint. More particularly, the present disclosure relates to a child car seat configured to attach to an underlying vehicle seat.

### SUMMARY

According to the present disclosure, a child restraint includes a juvenile seat adapted to hold a child for transportation in a vehicle and a seat base configured to support the juvenile seat and configured to attach to an underlying vehicle seat. The seat base includes a seat-base foundation and an angle-adjustment foot. The seat-base foundation is formed to include a belt-installation path configured to receive an attachment belt to secure the seat base to the vehicle seat. The angle-adjustment foot is configured to control a tilted orientation of the seat base and the juvenile seat relative to the vehicle seat.

In illustrative embodiments, the seat base further includes a belt-load indicator coupled to the seat-base foundation. The belt-load indicator is movable relative to the seat-base foundation from a first indication position to a second indication position. In the first indication position, the belt-load indicator displays a first indication when a load acting on the belt-installation path by the attachment belt is below a predetermined amount. In the second indication position, the belt-load indicator displays a second indication when the load acting on the belt-installation path by the attachment belt is at or above the predetermined amount.

In illustrative embodiments, the angle-adjustment foot is configured to translate relative to the seat-base foundation between an unloaded configuration when the load acting on the belt-installation path is below the predetermined amount and a loaded configuration when the load acting on the belt-installation path is at or above the predetermined amount. In the unloaded configuration, the angle-adjustment foot is positioned relative to the belt-load indicator so that the belt-load indicator assumes the first indication position to display the first indication. In the loaded configuration, the angle-adjustment foot engages the belt-load indicator to cause the belt-load indicator to move relative to the seat-base foundation so that the belt-load indicator assumes the second indication position to display the second indication.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is a perspective and diagrammatic view of a child restraint including a juvenile seat configured to hold a child for transportation in a vehicle and a seat base configured to support the juvenile seat and configured to be attached to an underlying vehicle seat, and showing that the seat base includes a seat-base foundation formed to include a belt-installation path configured to receive an attachment belt to secure the child restraint to the vehicle seat for transportation in the vehicle, an angle-adjustment foot configured to control a tilt orientation of the juvenile seat relative to the vehicle seat, and a belt-load indicator coupled to the seat-base foundation and configured to indicate when a load acting on the seat-base foundation by the attachment belt has reached a predetermined amount;

FIG. 2A is a side elevation and diagrammatic view showing the seat base in an unloaded configuration and the attachment belt routed across the belt-installation path with a load less than the predetermined amount;

FIG. 2B is an enlarged view of a portion of the seat base showing the belt-load indicator displaying a first indication when the seat base is in the unloaded configuration;

FIG. 3A is a side elevation and diagrammatic view showing the seat base in a loaded configuration and the attachment belt routed across the belt-installation path with a load of at least the predetermined amount and showing the angle-adjustment foot moved relative to the seat-base foundation in response to the load to cause the belt-load indicator to display a second indication;

FIG. 3B is an enlarged view of a portion of the seat base showing the belt-load indicator displaying the second indication when the seat base is in the loaded configuration;

FIG. 4 is a bottom perspective view with portions of the seat-base foundation shown in transparency to show that the angle-adjustment foot includes a foot carriage coupled to the seat-base foundation, a load post coupled to the foot carriage and movable relative to the foot carriage to adjust the tilt orientation of the juvenile seat, and a foot lock configured to block movement of the load post relative to the foot carriage in a locked position;

FIG. 5 is a cross section of a portion of the seat base taken along line 5-5 in FIG. 4 showing the angle-adjustment foot in the unloaded configuration and the belt-load indicator displaying the first indication through a window formed in the seat-base foundation;

FIG. 6 is a cross section of the portion of the seat base of FIG. 5 showing the angle-adjustment foot in the loaded configuration and engaged with the belt-load indicator to cause movement of the belt-load indicator to the second indication position displaying the second indication through the window;

FIG. 7 is a cross section of a portion of the seat base taken along line 7-7 in FIG. 5 showing the angle-adjustment foot in the unloaded configuration;

FIG. 8 is a cross section of a portion of the seat base taken along line 8-8 in FIG. 6 showing the angle-adjustment foot in the loaded configuration;

FIG. 9 is an enlarged view of a portion of the seat base showing the belt-load indicator including a foundation mount mounted to the seat-base foundation, an indicator body having the first indication and the second indication, and an indicator arm coupled to the indicator body and extending outwardly away from the indicator body for engagement with the angle-adjustment foot;

FIG. 10 is a cross section of a portion of the seat base showing the foot lock in a locked position and showing, in dashed lines, the foot lock in an unlocked position to free the load post for movement relative to the foot carriage;

FIG. 11 is a cross section and perspective view of a portion of the seat base showing the load post in a fully-extended position;

FIG. 12 is a cross section and perspective view of a portion of the seat base showing the load post in an intermediate position; and

FIG. 13 is a cross section and perspective view of a portion of the seat base showing the load post in a fully-retracted position.

### DETAILED DESCRIPTION

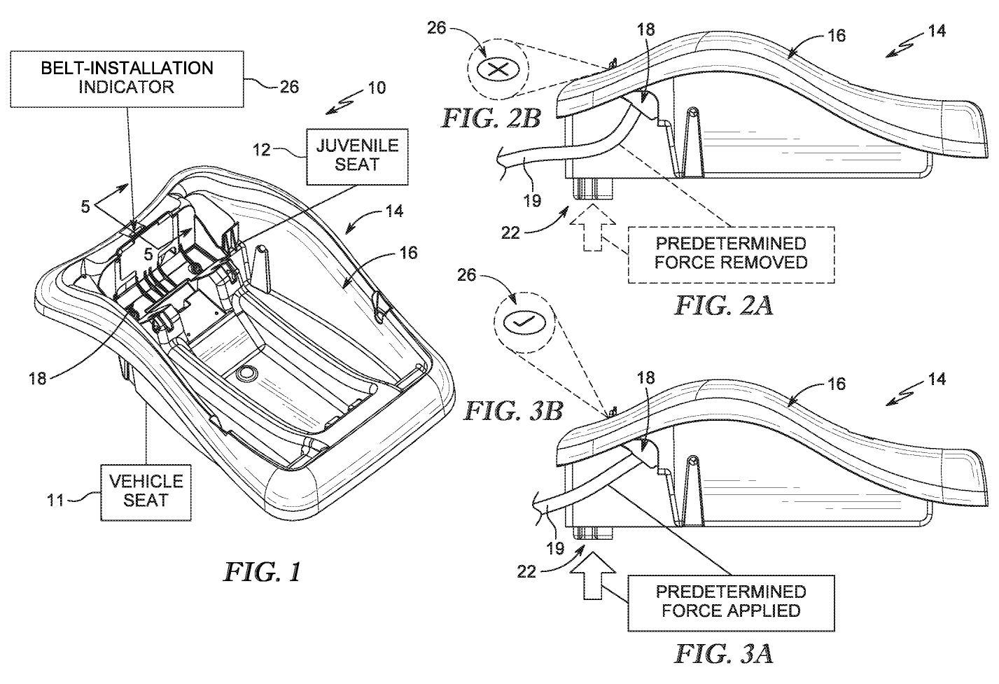

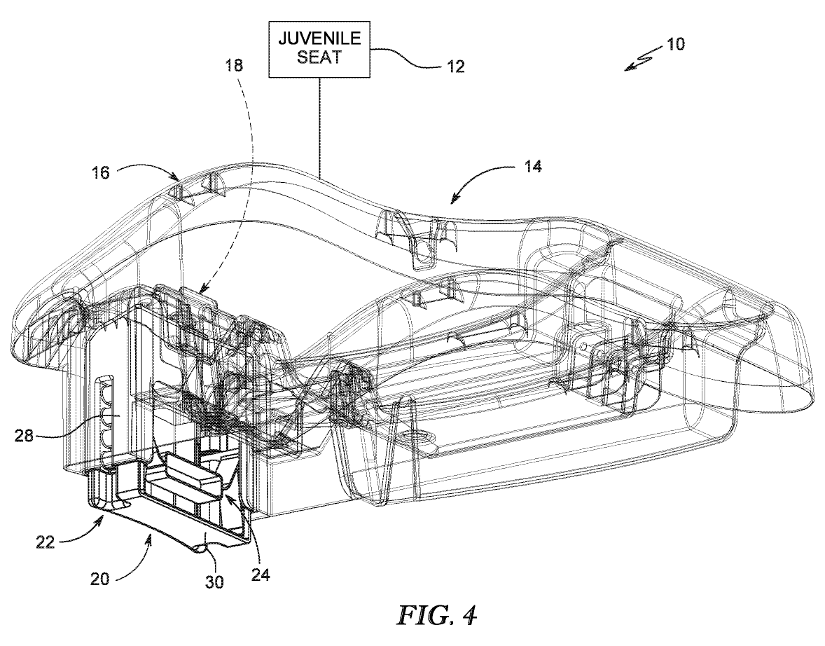

A child restraint 10 includes a juvenile seat 12 adapted to hold a child for transportation in a vehicle and a seat base 14 configured to support the juvenile seat 12 and configured to attach to an underlying vehicle seat 11 as shown in FIG. 1. The seat base 14 includes a seat-base foundation 16 and an angle-adjustment foot 22 coupled to the seat-base foundation 16. The seat-base foundation 16 is formed to include a belt-installation path 18 configured to receive an attachment belt 19 to secure the seat base 14 to the vehicle seat 11. The angle-adjustment foot 22 is configured to control a tilted orientation of the seat base 14 and the juvenile seat 12 relative to the vehicle seat 11.

The seat base 14 is configured to change from an unloaded configuration to a loaded configuration as shown in FIG. 2A and 3A. In the unloaded configuration, the attachment belt 19 is loose and imparts a force or load on the belt-installation path 18 less than a predetermined force as suggested in FIG. 2A. In the loaded configuration, the attachment belt 19 is tightened to impart a force or load on the belt-installation path 18 greater than or equal to the predetermined force. The seat base 14 is installed on the vehicle seat 11 in the loaded configuration when the force is at or greater than the predetermined force such that movement of the seat base 14 relative to the vehicle seat 11 is restricted as suggested in FIG. 3A (i.e. movement of the seat base 14 by more than 1 inch relative to the vehicle seat 11 is blocked).

In illustrative embodiments, the seat base 14 further includes a belt-load indicator 26 coupled to the seat-base foundation 16 to indicate an installation status of the attachment belt 19. The belt-load indicator 26 is movable relative to the seat-base foundation 16 and changes in response to tightening the attachment belt 19 from the unloaded configuration to the loaded configuration. The belt-load indicator 26 changes in from a first indication position in the unloaded configuration, as shown in FIG. 2B, to a second indication position in the loaded configuration, as shown in FIG. 3B. In the unloaded configuration, the belt-load indicator 26 assumes a first indication position and displays a first indication when a load acting on the belt-installation path by the attachment belt is below a predetermined amount. In the loaded configuration, the belt-load indicator 26 assumes a second indication position and displays a second indication when the load acting on the belt-installation path by the attachment belt is at or above the predetermined amount.

The angle-adjustment foot 22 is configured to translate relative to the seat-base foundation 16 between the unloaded configuration and the loaded configuration. In the unloaded configuration, the angle-adjustment foot 22 is not displaced relative to the seat-base foundation 16 and the angle-adjustment foot 22 is positioned relative to the belt-load indicator 26 so that the belt-load indicator 26 assumes the first indication position to display the first indication. In the loaded configuration, the angle-adjustment foot 22 is displaced relative to the seat-base foundation 16 and the angle-adjustment foot engages the belt-load indicator 26 to cause the belt-load indicator 26 to move relative to the seat-base foundation 16 so that the belt-load indicator 26 assumes the second indication position to display the second indication.

The angle-adjustment foot 22 includes a foot carriage 28, a load post 30, a foot lock 24, and a foot actuator 32. The foot carriage 28 is mounted to the seat-base foundation 16. The load post 30 is coupled to the foot carriage 28 and is movable relative to the foot carriage 28 to adjust a tilt orientation of the seat base 14. The foot lock 24 is configured to lock the load post 30 to the foot carriage 28 in one of a plurality of positions each corresponding to a different tilted orientation. The foot actuator 32 is configured to urge the foot carriage 28 and the load post 30 toward the unloaded configuration when the load on the belt-installation path 18 is below the predetermined amount.

The foot carriage 28 and the load post 30 are movable in unison with one another from the unloaded configuration to the loaded configuration when the foot lock 24 is locked. In response to tightening the attachment belt 19 across the belt-installation path 18, the attachment belt 19 imparts at least the predetermined amount of load on the belt-installation path 18 to cause the foot carriage 28 and the load post 30 to translate relative to the seat-base foundation 16 from the unloaded configuration to the loaded configuration.

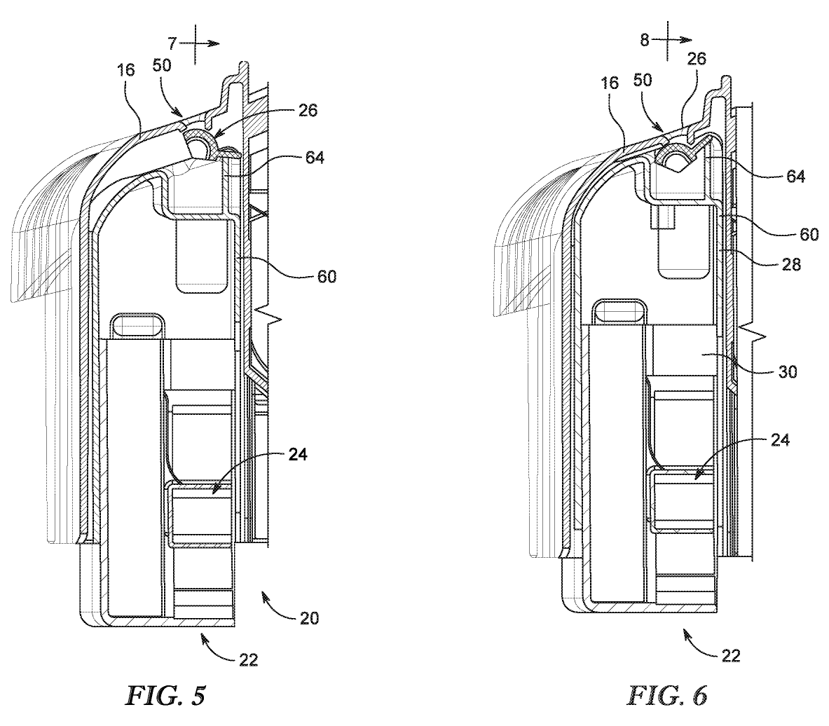

The foot carriage 28 includes a carriage body 60 coupled to the seat-base foundation, an actuator post 62 coupled to the carriage body 60, and an indicator pusher 64 coupled to the carriage body 60 as shown in FIGS. 5-8. The carriage body 60 is coupled to the load post 30. The actuator post 62 is formed to include an actuator-receiving space 63 configured to receive at least a portion of the foot actuator 32. The indicator pusher 64 is configured to engage the belt-load indicator 26 to move the belt-load indicator 26 from the first indication position to the second indication position in response to the foot carriage 28 translating from the unloaded configuration to the loaded configuration. In some embodiments, the actuator post 30 is omitted. In some embodiments, indicator pusher 64 is engaged with the belt-load indicator 26 both the unload configuration and the loaded configuration.

The load post 30 is at least partially received within a cavity 61 formed by the foot carriage 28 as shown in FIGS. 5-8. An interior surface 65 of the carriage body 60 facing the load post 30 is formed to include a plurality of notches 40 stacked in a vertical direction relative to one another. The foot lock 24 is configured to extend into at least one notch included in the plurality of notches 40 to block translation of the load post 30 relative to the foot carriage 28. When the foot lock 24 is withdrawn from the plurality of notches 40, the load post 30 is free to translate in the vertical direction relative to the foot carriage 28 to adjust the tilted orientation of the seat base 14. In other embodiments, the load post 30 may include a cavity that receives the foot carriage 28.

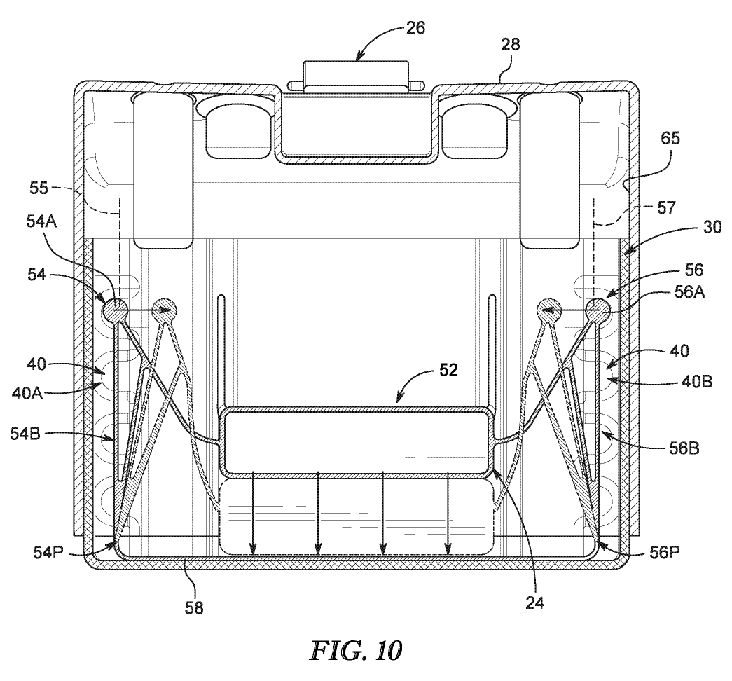

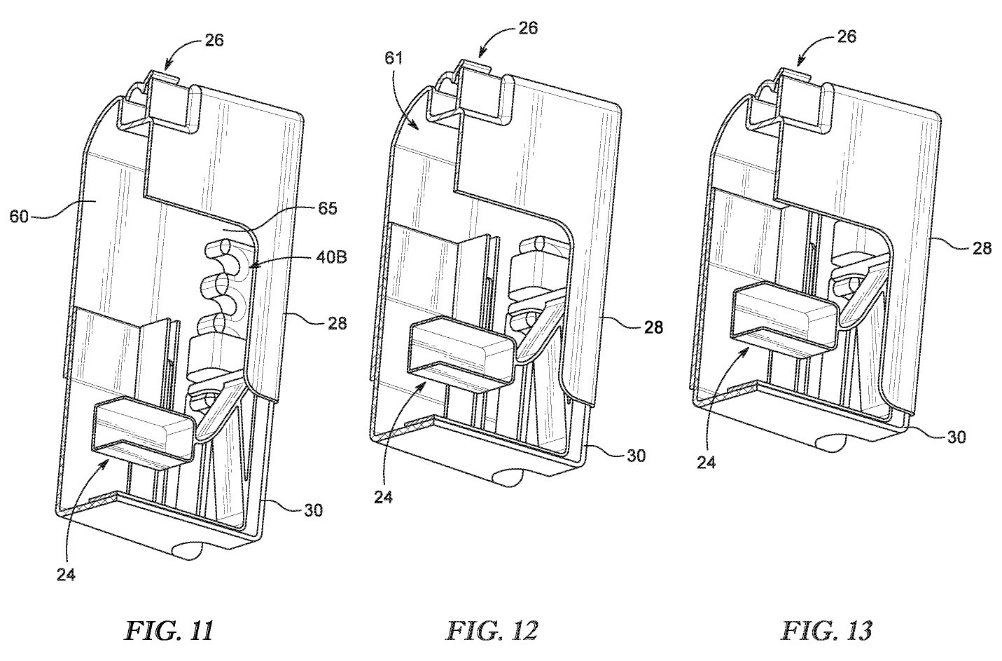

The foot lock 24 includes a hand grip 52, a first post retainer 54 coupled to a first side of the hand grip 52, and a second post retainer 56 coupled to an opposite second side of the hand grip 52 as shown in FIG. 10. The first post retainer 54 is configured to interact with a first set of notches 40A included in the plurality of notches 40. The second post retainer 56 is configured to interact with a second set of notches 40B included in the plurality of notches 40.

The first and second post retainers 54, 56 each include a post latch 54A, 56A and a support post 54B, 56B as shown in FIG. 10. The post latches 54A, 56A are configured to extend into a respective notch of the first set of notches 40A and the second set of notches 40B, respectively. The support posts 54B, 56B each have an upper end coupled to each respective post latch 54A, 56A and a lower end fixed in position relative to the load post 30 to provide a load path from each post latch 54A, 56A to the load post 30. In this way, forces acting on the load post 30 from the vehicle seat in response to tightening the attachment belt 19 are transferred from the load post 30, through the post retainers 54, 56 to the foot carriage 28 to block movement of the load post 30 relative to the foot carriage 28 when the foot lock 24 is in the locked position.

In some embodiments, the foot lock 24 further includes a bottom strip 58 extending between and interconnecting the lower end of each support post 54B, 56B and spaced apart from the hand grip 52 as shown in FIG. 10. The bottom strip 58 maintains spacing between the lower ends of the support posts 54B, 56B to provide pivot points 54P, 56P. The first and second post retainers 54, 56 are configured to pivot about the pivot points 54P, 56P at the lower end of each support post 54B, 56B in response to movement of the handgrip 52 from a locked position spaced a first distance from the bottom strip 58 to an unlocked position spaced a second distance from the bottom strip 58 less than the first distance. Each support post 54B, 56B extends along a plane 55, 57 aligned with each notch included in the first and second sets of notches 40A, 40B, respectively, when the foot lock 24 is in a locked position. This provides support along the planes 55, 57 parallel with a direction of the load acting on the load post 30. In some embodiments, the bottom strip 58 is omitted.

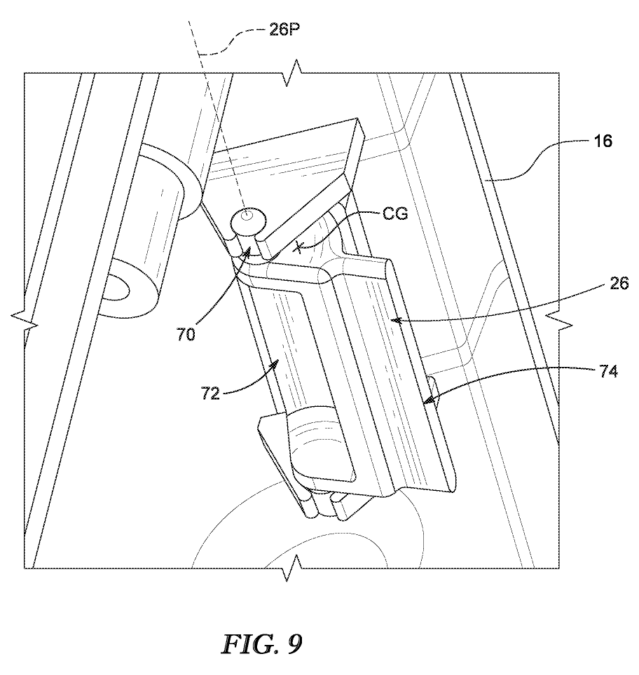

The belt-load indicator 26 is coupled to the seat-base foundation 16 for pivotable movement about a pivot axis 26P to pivot relative to the seat-base foundation 16 between the first indication position and the second indication position as suggested in FIG. 9. The belt-load indicator 26 includes an indicator mount 70, an indicator body 72, and an indicator arm 74. The indicator mount 70 is configured to mount the belt-load indicator 26 to the seat-base foundation 16 for movement about the pivot axis 26P. The indicator body 72 has the first indication and the second indication coupled thereto and is coupled to the indicator mount 70 for movement therewith. The indicator arm 74 is coupled to the indicator body 72 and extends radially outward from the indicator body 70 away from the pivot axis 26P to engage with the angle-adjustment foot 22 in the loaded configuration.

A center of gravity CG of the belt-load indicator 26 is offset from the pivot axis 26P by way of the indicator arm 74. In this way, the indicator arm 74 causes the belt-load indicator 26 to pivot toward the first indication position under the influence of gravity when the angle-adjustment foot 22 is in the unloaded configuration. In some embodiments, a spring or other resilient element may be coupled to the belt-load indicator 26 to bias the belt-load indicator 26 toward the first indication position. Such springs or other resilient element may be or may be included in the foot actuator 32.

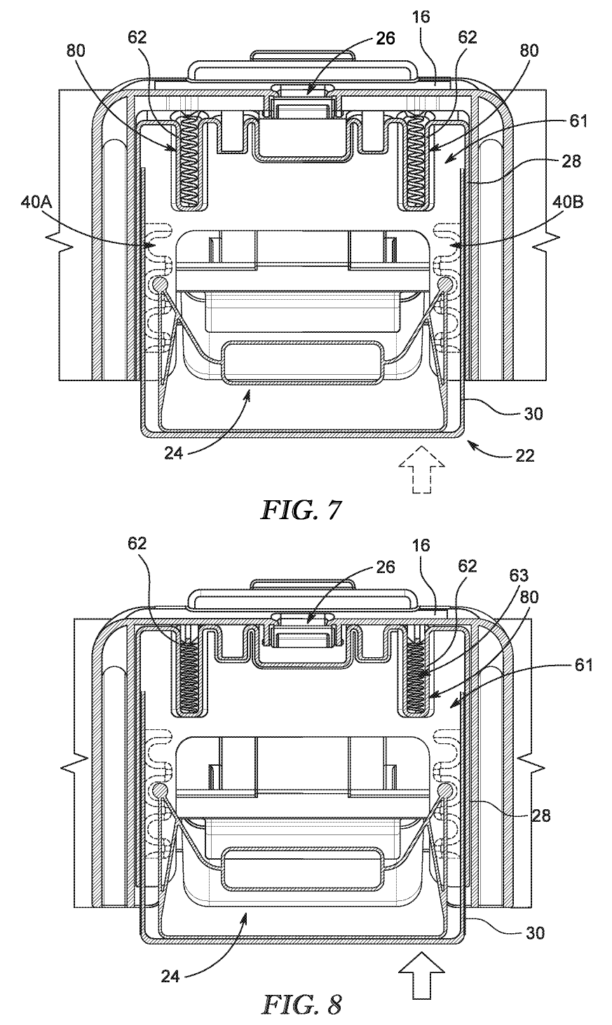

The foot actuator 32 includes one or more springs 80 extending between the seat-base foundation 16 and the foot carriage 28 as shown in FIGS. 7 and 8. Illustratively, the foot actuator 32 includes a pair of compression springs 80, one located on each lateral side of the belt-load indicator 26. This provides an even distribution of force relative to the belt-load indicator 26. The springs 80 have a spring constant which is selected to provide the predetermined force required to change the angle-adjustment foot 22 from the unloaded configuration to the loaded configuration. In some embodiments, the predetermined force is at least 25 lbs so that the predetermined force is sufficiently high to substantially block movement of the seat base 14 relative to the vehicle seat 11. In some embodiments, the predetermined force is at least 20 lbs. In some embodiments, the predetermined force is at least 15 lbs. In some embodiments, the predetermined force is at least 10 lbs.

In the illustrative embodiment, movement of the angle-adjuster foot 22 from the unloaded configuration to the loaded configuration causes the tilted orientation to change by no more than 5 degrees. In some embodiments, movement of the angle-adjuster foot 22 from the unloaded configuration to the loaded configuration causes the tilted orientation to change by no more than 4 degrees. In some embodiments, movement of the angle-adjuster foot 22 from the unloaded configuration to the loaded configuration causes the tilted orientation to change by no more than 3 degrees. In some embodiments, movement of the angle-adjuster foot 22 from the unloaded configuration to the loaded configuration causes the tilted orientation to change by no more than 2 degrees. In some embodiments, movement of the angle-adjuster foot 22 from the unloaded configuration to the loaded configuration causes the tilted orientation to change by no more than 1 degree. In this way, the loaded configuration does not substantially change the tilted orientation of the seat base 14 set by a user prior to tightening the attachment belt 19.

It should be appreciated that the angle-adjustment foot 22 may not be adjustable in some embodiments. In such a case, the angle-adjustment foot 22 is used only as a foot that translates relative to the seat-base foundation 16 to actuate the belt-load indicator 26 once the predetermined force is reached. It should also be noted that the seat-base foundation 16 may not include a belt path 18 in some embodiments. In such a case, the attachment belt 19 can be attached directly to the seat-base foundation 16 at one or more anchor points.

A child restraint 10 includes a juvenile seat 12 and a seat base 14. The juvenile seat 12 is configured to hold a child for transportation in a vehicle. The seat base 14 is configured to attach to the vehicle seat and support the juvenile seat 12. In some embodiments, the juvenile seat 12 and the seat base 14 are separable from one another. In other embodiments, the juvenile seat 12 and the seat base 14 are attached to one another such that the seat base 12 forms a part of the juvenile seat 14.

The seat base 14 includes a seat-base foundation 16, a belt-installation path 18 coupled to the seat-base foundation 16, and an angle-adjustment unit 20. The juvenile seat 12 is configured to mount to the seat-base foundation 16. The belt-installation path 18 is configured to receive or engage an attachment belt (i.e. a vehicle lap belt or a separate attachment belt) to secure the seat base 14 and the juvenile seat 12 to the vehicle seat when the attachment belt is tightened. The angle-adjustment unit 20 is configured to control a tilted orientation of the seat base 14 and the juvenile seat 12 relative to the vehicle seat. The angle-adjustment unit 20 also provides means for indicating installation of the attachment belt in response to the angle-adjustment foot moving from an unloaded position when a load acting on the belt path by the attachment belt is below a predetermined amount to a loaded position when the load acting on the belt path by the attachment belt is at or above the predetermined amount so that a user is notified when the attachment belt is installed.

The angle-adjustment unit 20 includes an angle-adjustment foot 22, a foot lock 24, and a belt-load indicator 26. The angle adjustment foot 22 is configured to be moved relative to the seat-base foundation 16 to adjust the tilted orientation of the seat base 14 and the juvenile seat 12. The foot lock 24 is configured to lock the angle-adjustment foot 22 in one of a plurality of positions each corresponding to a different tilted orientation. The belt-load indicator 26 is configured to display a first indication when the load acting on the belt-installation path 18 is below the predetermined amount and a second indication when the load acting on the belt-installation path 18 is at or above the predetermined amount.

The angle-adjustment foot 22 includes a foot carriage 28, a load post 30, and an foot actuator 32, the foot carriage 28 is mounted to the seat-base foundation 16 within a cavity. The load post 30 is coupled to the foot carriage 28 and is movable relative to the foot carriage 28 when the foot lock 24 is unlocked to adjust the tilt orientation of the seat base 14. The foot actuator 32 is configured to urge the foot carriage 28 and the load post 30 toward the unloaded configuration where the belt-load indicator 26 displays the first indication through a window 50 formed in the seat-base foundation 16.

The foot carriage 28 and the load post 30 are movable in unison with one another when the foot lock 24 is locked and in response to tightening the attachment belt across the belt-installation path 18 to impart at least the predetermined amount of load on the belt-installation path 18. The foot carriage 28 and the load post 30 are configured to move from the unloaded configuration to the loaded configuration to cause movement of the belt-load indicator 26 relative to the seat-base foundation 16 from a first indication position displaying the first indication through the window 50 to a second indication position displaying the second indication through the window 50. The belt-installation indicator 26 is biased toward the first indication position by gravity in the illustrative embodiment but can be biased by one or more bias members, such as springs, in other embodiments.

The foot carriage 28 is formed to include a plurality of angle adjustment notches or ledges 40. The foot lock 24 is configured to extend into or engage a respective notch or ledge 40 to lock the load post 30 in position relative to the foot carriage 28 in one of the tilted orientations. The foot lock 24 is at least partially made from a flexible material and is configured to deform when moved from a locked position to an unlocked position. The foot lock 24 includes a hand grip 52 and left and right post retainers 54, 56 coupled to the hand grip 52. The hand grip 52 is configured to be pulled downwardly to cause flexion of the left and right post retainer 54, 56 so that the left and right post retainers 54, 56 withdraw from the notches 40 formed in the foot carriage 28 to the unlocked position.

The foot actuator 32 includes one or more springs 80 configured to urge the foot carriage 28 toward the unloaded configuration. One or more guides, such as a post or a rail, can interface with the foot carriage 28 and guide translation of the foot carriage 28 and the load post 30 relative to the seat-base foundation 16.

The following numbered clauses include embodiments that are contemplated and non-limiting:

Clause 1. A child restraint including a juvenile seat adapted to hold a child for transportation in a vehicle.

Clause 2. The child restraint of clause 1, any other suitable clause, or any suitable combination of clauses, including a seat base configured to support the juvenile seat and configured to attach to an underlying vehicle seat.

Clause 3. The child restraint of clause 2, any other suitable clause, or any suitable combination of clauses, the seat base including a seat-base foundation formed to include a belt-installation path configured to receive an attachment belt to secure the seat base to the vehicle seat, an angle-adjustment foot configured to control a tilted orientation of the seat base and the juvenile seat relative to the vehicle seat, and a belt-load indicator coupled to the seat-base foundation and movable relative to the seat-base foundation from a first indication position, in which the belt-load indicator displays a first indication when a load acting on the belt-installation path by the attachment belt is below a predetermined amount, to a second indication position, in which the belt-load indicator displays a second indication when the load acting on the belt-installation path by the attachment belt is at or above the predetermined amount.

Clause 4. The child restraint of clause 3, any other suitable clause, or any suitable combination of clauses, the angle-adjustment foot is configured to translate relative to the seat-base foundation between an unloaded configuration when the load acting on the belt-installation path is below the predetermined amount, in which the angle-adjustment foot is positioned relative to the belt-load indicator so that the belt-load indicator assumes the first indication position to display the first indication, and a loaded configuration when the load acting on the belt-installation path is at or above the predetermined amount, in which the angle-adjustment foot engages the belt-load indicator to cause the belt-load indicator to move relative to the seat-base foundation so that the belt-load indicator assumes the second indication position to display the second indication.

Clause 5. The child restraint of clause 4, any other suitable clause, or any suitable combination of clauses, wherein the angle-adjustment foot includes a foot carriage mounted to the seat-base foundation, a load post coupled to the foot carriage and movable relative to the foot carriage to adjust a tilt orientation of the seat base, a foot lock configured to lock the load post to the foot carriage in one of a plurality of positions each corresponding to a different tilted orientation, and a foot actuator configured to urge the foot carriage and the load post toward the unloaded configuration when the load on the belt-installation path is below the predetermined amount.

Clause 6. The child restraint of clause 5, any other suitable clause, or any suitable combination of clauses, the foot carriage and the load post are movable in unison with one another from the unloaded configuration to the loaded configuration when the foot lock is locked and in response to tightening the attachment belt across the belt-installation path to impart at least the predetermined amount of load on the belt-installation path.

Clause 7. The child restraint of clause 5, any other suitable clause, or any suitable combination of clauses, the load post is at least partially received within a cavity formed by the foot carriage.

Clause 8. The child restraint of clause 5, any other suitable clause, or any suitable combination of clauses, the foot carriage includes a carriage body coupled to the seat-base foundation, an actuator post coupled to the carriage body and formed to include an actuator-receiving space configured to receive at least a portion of the foot actuator, and an indicator pusher coupled to the carriage body and configured to engage the belt-load indicator to move the belt-load indicator from the first indication position to the second indication position in response to the foot carriage translating from the unloaded configuration to the loaded configuration.

Clause 9. The child restraint of clause 8, any other suitable clause, or any suitable combination of clauses, wherein an interior surface of the foot carriage facing the load post is formed to include a plurality of notches, and the foot lock is configured to extend into at least one notch included in the plurality of notches to block translation of the load post relative to the foot carriage.

Clause 10. The child restraint of clause 9, any other suitable clause, or any suitable combination of clauses, wherein the foot lock includes a hand grip, a first post retainer coupled to a first side of the hand grip and configured to interact with a first set of notches included in the plurality of notches, a second post retainer coupled to a second end of the hand grip and configured to interact with a second set of notches included in the plurality of notches.

Clause 11. The child restraint of clause 10, any other suitable clause, or any suitable combination of clauses, wherein the first and second post retainers each include a post latch configured to extend into a respective notch of the first set of notches and the second set of notches, respectively, and a support post having an upper end coupled to the post latch and a lower end fixed in position relative to the load post to provide a load path from the post latch to the load post.

Clause 12. The child restraint of clause 11, any other suitable clause, or any suitable combination of clauses, wherein the foot lock further includes a bottom strip extending between and interconnecting lower end of each support post and spaced apart from the hand grip, and wherein the first and second post retainers are configured to pivot about the lower end of each support post in response to movement of the handgrip from a locked position spaced a first distance from the bottom strip to an unlocked position spaced a second distance from the bottom strip less than the first distance.

Clause 13. The child restraint of clause 11, any other suitable clause, or any suitable combination of clauses, wherein each support post extends along a plane aligned with each notch included in the first and second sets of notches, respectively, when the foot lock is in a locked position.

Clause 14. The child restraint of clause 4, any other suitable clause, or any suitable combination of clauses, wherein the belt-load indicator is coupled to the seat-base foundation for pivotable movement about a pivot axis to pivot relative to the seat-base foundation between the first indication position and the second indication position.

Clause 15. The child restraint of clause 14, any other suitable clause, or any suitable combination of clauses, wherein the belt-load indicator includes an indicator mount configured to mount the belt-load indicator to the seat-base foundation for movement about the pivot axis, an indicator body having the first indication and the second indication and coupled to the indicator mount for movement therewith, and an indicator arm coupled to the indicator body and extending radially outward from the indicator body away from the pivot axis to engage with the angle adjustment foot in the loaded configuration.

Clause 16. The child restraint of clause 15, any other suitable clause, or any suitable combination of clauses, wherein a center of gravity of the belt-load indicator is offset from the pivot axis and the indicator arm causes the belt-load indicator to pivot toward the first indication position when disengaged from the angle-adjustment foot under the influence of gravity.

Clause 17. The child restraint of clause 4, any other suitable clause, or any suitable combination of clauses, wherein movement of the angle-adjuster foot from the unloaded configuration to the loaded configuration causes the tilted orientation to change by no more than 5 degrees.

Clause 18. A seat base configured to support a juvenile seat and configured to attach to an underlying vehicle seat.

Clause 19. The seat base of clause 18, any other suitable clause, or any suitable combination of clauses, the seat base including a seat-base foundation configured to attach to the vehicle seat using an attachment belt to secure the seat base to the vehicle seat.

Clause 20. The seat base of clause 19, any other suitable clause, or any suitable combination of clauses, the seat base including a foot coupled to the seat-base foundation and configured to engage the vehicle seat.

Clause 21. The seat base of clause 20, any other suitable clause, or any suitable combination of clauses, the seat base including a belt-load indicator movable relative to the seat-base foundation from a first indication position, in which the belt-load indicator displays a first indication when a load acting on the seat-base foundation by the attachment belt is below a predetermined amount, to a second indication position, in which the belt-load indicator displays a second indication when the load acting on the seat-base foundation by the attachment belt is at or above a predetermined amount.

Clause 22. The seat base of clause 21, any other suitable clause, or any suitable combination of clauses, wherein the foot is configured to move relative to the seat-base foundation between an unloaded configuration when the load acting on the seat-base foundation is below the predetermined amount, in which the foot is positioned relative to the belt-load indicator so that the belt-load indicator assumes the first indication position to display the first indication, and a loaded configuration when the load acting on the seat-base foundation is at or above the predetermined amount, in which the foot engages the belt-load indicator to cause the belt-load indicator to move relative to the seat-base foundation so that the belt-load indicator assumes the second indication position to display the second indication.

Clause 23. The seat base of clause 22, any other suitable clause, or any suitable combination of clauses, wherein the foot includes a foot carriage mounted to the seat-base foundation, a load post coupled to the foot carriage and movable relative to the foot carriage to adjust the tilt orientation of the seat base, a foot lock configured to lock the load post to the foot carriage in one of a plurality of positions each corresponding to a different tilt orientation, and a foot actuator configured to urge the foot carriage and the load post toward the unloaded configuration when the load on the seat-base foundation is below the predetermined amount.

Clause 24. The seat base of clause 23, any other suitable clause, or any suitable combination of clauses, wherein the foot carriage and the load post are movable in unison with one another from the unloaded configuration to the loaded configuration when the foot lock is locked and in response to tightening the attachment belt across the seat-base foundation to impart at least the predetermined amount of load on the seat-base foundation.

Clause 25. The seat base of clause 24, any other suitable clause, or any suitable combination of clauses, wherein the load post is at least partially received within a cavity formed by the foot carriage.

Clause 26. The seat base of clause 23, any other suitable clause, or any suitable combination of clauses, wherein the foot carriage includes a carriage body coupled to the seat-base foundation, an actuator post coupled to the carriage body and formed to include an actuator-receiving space configured to receive at least a portion of the foot actuator, and an indicator pusher coupled to the carriage body and configured to engage the belt-load indicator to move the belt-load indicator from the first indication position to the second indication position in response to the foot carriage translating from the unloaded configuration to the loaded configuration.

Clause 27. The seat base of clause 23, any other suitable clause, or any suitable combination of clauses, wherein the foot lock includes a hand grip, a first post retainer coupled to a first side of the hand grip and configured to interact with a first set of notches formed in the foot carriage, a second post retainer coupled to a second end of the hand grip and configured to interact with a second set of notches formed in the foot carriage.

Clause 28. The seat base of clause 27, any other suitable clause, or any suitable combination of clauses, wherein the first and second post retainers each include a post latch configured to extend into a respective notch of the first set of notches and the second set of notches, respectively, and a support post having an upper end coupled to the post latch and a lower end in contact with a lower end of the load post to provide a load path from the post latch to the bottom end of the load post.

1. A child restraint comprising
a juvenile seat adapted to hold a child for transportation in a vehicle, and
a seat base configured to support the juvenile seat and configured to attach to an underlying vehicle seat, the seat base including a seat-base foundation formed to include a belt-installation path configured to receive an attachment belt to secure the seat base to the vehicle seat, an angle-adjustment foot configured to control a tilted orientation of the seat base and the juvenile seat relative to the vehicle seat, and a belt-load indicator coupled to the seat-base foundation and movable relative to the seat-base foundation from a first indication position, in which the belt-load indicator displays a first indication when a load acting on the belt-installation path by the attachment belt is below a predetermined amount, to a second indication position, in which the belt-load indicator displays a second indication when the load acting on the belt-installation path by the attachment belt is at or above the predetermined amount,
wherein the angle-adjustment foot is configured to translate relative to the seat-base foundation between an unloaded configuration when the load acting on the belt-installation path is below the predetermined amount, in which the angle-adjustment foot is positioned relative to the belt-load indicator so that the belt-load indicator assumes the first indication position to display the first indication, and a loaded configuration when the load acting on the belt-installation path is at or above the predetermined amount, in which the angle-adjustment foot engages the belt-load indicator to cause the belt-load indicator to move relative to the seat-base foundation so that the belt-load indicator assumes the second indication position to display the second indication.

2. The child restraint of claim 1, wherein the angle-adjustment foot includes a foot carriage mounted to the seat-base foundation, a load post coupled to the foot carriage and movable relative to the foot carriage to adjust a tilt orientation of the seat base, a foot lock configured to lock the load post to the foot carriage in one of a plurality of positions each corresponding to a different tilted orientation, and a foot actuator configured to urge the foot carriage and the load post toward the unloaded configuration when the load on the belt-installation path is below the predetermined amount.

3. The child restraint of claim 2, wherein the foot carriage and the load post are movable in unison with one another from the unloaded configuration to the loaded configuration when the foot lock is locked and in response to tightening the attachment belt across the belt-installation path to impart at least the predetermined amount of load on the belt-installation path.

4. The child restraint of claim 2, wherein the load post is at least partially received within a cavity formed by the foot carriage.

5. The child restraint of claim 2, wherein the foot carriage includes a carriage body coupled to the seat-base foundation, an actuator post coupled to the carriage body and formed to include an actuator-receiving space configured to receive at least a portion of the foot actuator, and an indicator pusher coupled to the carriage body and configured to engage the belt-load indicator to move the belt-load indicator from the first indication position to the second indication position in response to the foot carriage translating from the unloaded configuration to the loaded configuration.

6. The child restraint of claim 5, wherein an interior surface of the foot carriage facing the load post is formed to include a plurality of notches, and the foot lock is configured to extend into at least one notch included in the plurality of notches to block translation of the load post relative to the foot carriage.

7. The child restraint of claim 6, wherein the foot lock includes a hand grip, a first post retainer coupled to a first side of the hand grip and configured to interact with a first set of notches included in the plurality of notches, a second post retainer coupled to a second end of the hand grip and configured to interact with a second set of notches included in the plurality of notches.

8. The child restraint of claim 7, wherein the first and second post retainers each include a post latch configured to extend into a respective notch of the first set of notches and the second set of notches, respectively, and a support post having an upper end coupled to the post latch and a lower end fixed in position relative to the load post to provide a load path from the post latch to the load post.

9. The child restraint of claim 8, wherein the foot lock further includes a bottom strip extending between and interconnecting lower end of each support post and spaced apart from the hand grip, and wherein the first and second post retainers are configured to pivot about the lower end of each support post in response to movement of the handgrip from a locked position spaced a first distance from the bottom strip to an unlocked position spaced a second distance from the bottom strip less than the first distance.

10. The child restraint of claim 8, wherein each support post extends along a plane aligned with each notch included in the first and second sets of notches, respectively, when the foot lock is in a locked position.

11. The child restraint of claim 1, wherein the belt-load indicator is coupled to the seat-base foundation for pivotable movement about a pivot axis to pivot relative to the seat-base foundation between the first indication position and the second indication position.

12. The child restraint of claim 11, wherein the belt-load indicator includes an indicator mount configured to mount the belt-load indicator to the seat-base foundation for movement about the pivot axis, an indicator body having the first indication and the second indication and coupled to the indicator mount for movement therewith, and an indicator arm coupled to the indicator body and extending radially outward from the indicator body away from the pivot axis to engage with the angle adjustment foot in the loaded configuration.

13. The child restraint of claim 12, wherein a center of gravity of the belt-load indicator is offset from the pivot axis and the indicator arm causes the belt-load indicator to pivot toward the first indication position when disengaged from the angle-adjustment foot under the influence of gravity.

14. The child restraint of claim 1, wherein movement of the angle-adjuster foot from the unloaded configuration to the loaded configuration causes the tilted orientation to change by no more than 5 degrees.

15. A seat base configured to support a juvenile seat and configured to attach to an underlying vehicle seat, the seat base comprising:
a seat-base foundation configured to attach to the vehicle seat using an attachment belt to secure the seat base to the vehicle seat,
a foot coupled to the seat-base foundation and configured to engage the vehicle seat, and
a belt-load indicator movable relative to the seat-base foundation from a first indication position, in which the belt-load indicator displays a first indication when a load acting on the seat-base foundation by the attachment belt is below a predetermined amount, to a second indication position, in which the belt-load indicator displays a second indication when the load acting on the seat-base foundation by the attachment belt is at or above a predetermined amount,
wherein the foot is configured to move relative to the seat-base foundation between an unloaded configuration when the load acting on the seat-base foundation is below the predetermined amount, in which the foot is positioned relative to the belt-load indicator so that the belt-load indicator assumes the first indication position to display the first indication, and a loaded configuration when the load acting on the seat-base foundation is at or above the predetermined amount, in which the foot engages the belt-load indicator to cause the belt-load indicator to move relative to the seat-base foundation so that the belt-load indicator assumes the second indication position to display the second indication.

16. The seat base of claim 1, wherein the foot includes a foot carriage mounted to the seat-base foundation, a load post coupled to the foot carriage and movable relative to the foot carriage to adjust the tilt orientation of the seat base, a foot lock configured to lock the load post to the foot carriage in one of a plurality of positions each corresponding to a different tilt orientation, and a foot actuator configured to urge the foot carriage and the load post toward the unloaded configuration when the load on the seat-base foundation is below the predetermined amount.

17. The seat base of claim 16, wherein the foot carriage and the load post are movable in unison with one another from the unloaded configuration to the loaded configuration when the foot lock is locked and in response to tightening the attachment belt across the seat-base foundation to impart at least the predetermined amount of load on the seat-base foundation.

18. The seat base of claim 17, wherein the load post is at least partially received within a cavity formed by the foot carriage.

19. The seat base of claim 16, wherein the foot carriage includes a carriage body coupled to the seat-base foundation, an actuator post coupled to the carriage body and formed to include an actuator-receiving space configured to receive at least a portion of the foot actuator, and an indicator pusher coupled to the carriage body and configured to engage the belt-load indicator to move the belt-load indicator from the first indication position to the second indication position in response to the foot carriage translating from the unloaded configuration to the loaded configuration.

20. The seat base of claim 16, wherein the foot lock includes a hand grip, a first post retainer coupled to a first side of the hand grip and configured to interact with a first set of notches formed in the foot carriage, a second post retainer coupled to a second end of the hand grip and configured to interact with a second set of notches formed in the foot carriage, and
wherein the first and second post retainers each include a post latch configured to extend into a respective notch of the first set of notches and the second set of notches, respectively, and a support post having an upper end coupled to the post latch and a lower end in contact with a lower end of the load post to provide a load path from the post latch to the bottom end of the load post.
